(19) United States
(12) Patent Application Publication
(10) Pub. No.: US 2022/0396523 A1
(43) Pub. Date: Dec. 15, 2022

(54) Method For Making Concrete And Concrete Structures Having 3-Dimensional Carbon Nanomaterial Networks

(71) Applicant: EDEN INNOVATIONS LTD., Perth (AU)

(72) Inventors: Allan Godsk Larsen, Gentofte (DK); Justin Fulton, Fort Collins, CO (US); Dustin Marion Hulbert, Highlands Ranch, CO (US); Gregory H. Solomon, Cottlesloe (AU)

(73) Assignee: EDEN INNOVATIONS LTD., Perth (AU)

(21) Appl. No.: 17/838,337

(22) Filed: Jun. 13, 2022

Related U.S. Application Data
(60) Provisional application No. 63/210,519, filed on Jun. 15, 2021.

(51) Int. Cl. C04B 14/02

(52) U.S. Cl. CPC C04B 14/022; C04B 2111/00258

(57) ABSTRACT

A method for making concrete and concrete structures includes: providing a liquid admixture with a carbon nanomaterial in a liquid aqueous or organic solvent/compound mixture, mixing the liquid admixture with cement and water in a dosage selected to form a concrete mix having a carbon nanomaterial structure having individual carbon nanomaterial particles with a unit cell overlap, and hardening the concrete mix to form a concrete matrix with the carbon nanomaterial forming a 3-dimensional carbon nanomaterial network incorporated into the concrete matrix. The 3-dimensional carbon nanomaterial network has a shielding effect against high frequency electromagnetic pulses and other radiofrequency signals.

### CROSS REFERENCE TO RELATED APPLICATION

This application claims priority from U.S. Provisional No. 63/210,519, filed Jun. 15, 2021, which is incorporated herein by reference.

### FIELD

This disclosure relates to a method for making concrete and concrete structures having 3-dimensional carbon nanomaterial networks in a concrete matrix.

### BACKGROUND

Integration of carbon nanomaterial in concrete is known to add significant benefit to multiple properties of the concrete. Most focus has been on various strength benefits in the hardened state of the concrete, but secondary effects to the hardened state of concrete, such as increased abrasion resistance, reduced shrinkage, reduced water and chloride permeability, and overall better durability, have attracted significant interest and have been studied extensively.

Carbon nanomaterial can be added to the wet concrete either as dry powder or in a pre-dispersed liquid state. Carbon nanomaterial can include carbon nanoparticles, such as carbon nanotubes (CNTs) and carbon nanofibers (CNFs), as well as other types of carbon nanomaterial, such as graphene particles, graphite particles and carbon black.

The present disclosure is directed to a method for making concrete and concrete structures with a 3-dimensional carbon nanomaterial network in the concrete. The 3-dimensional carbon nanomaterial network provides useful electrical characteristics in the cured concrete. For example, shielding effects of the concrete in relation to radiofrequency and electromagnetic pulse radiation, Faraday cage like properties of the concrete, and electrically conducting concrete.

### SUMMARY

A method for making concrete and concrete structures includes the step of providing a liquid admixture comprising a carbon nanomaterial having a predetermined percentage range by mass of admixture in a liquid aqueous or organic solvent/compound mixture. The liquid admixture is formulated such that the carbon nanomaterial is in a pre-dispersed and deagglomerated state. This state secures optimal performance of the individual carbon nanomaterial particles, and reduces the risk of “simple” re-agglomeration driven by Van der Waals forces. Blocking of Van der Waals driven agglomeration can also be accomplished by addition of dispersion stabilizing chemistry. The pre-dispersed and deagglomerated state increases the likelihood of an extended 3-dimensional network formation having end-to-end carbon nanomaterial particle coordination.

The method also includes the step of mixing the liquid admixture with cement and water in a dosage selected to form a concrete mix having a carbon nanomaterial structure comprised of individual carbon nanomaterial particles having a unit cell overlap. The mixing step can also include the mixing of aggregates to the concrete mix such as minerals, sand, and stones in selected weight percentage ranges. For a pozzolan concrete, the mixing step can also include the addition and mixing of pozzolan in the concrete mix. The concrete mixing step can be performed in a single step, or in stages in which the liquid concrete admixture can be mixed with the cement and water in a first stage followed by mixing of the aggregates in a second stage.

The method also includes the step hardening the concrete mix to form a concrete matrix with the carbon nanomaterial forming a 3-dimensional carbon nanomaterial network incorporated into the concrete matrix. The 3-dimensional carbon nanomaterial network has a shielding effect against high frequency electromagnetic pulses and other radiofrequency signals.

The method can also include the step of building a structure using the concrete, and the step of shielding a structure from radiofrequency and electromagnetic pulse radiation using the concrete.

A concrete with a 3-dimensional carbon nanomaterial network includes a concrete matrix comprised of cement, sand, water, and aggregate and a carbon nanomaterial having a predetermined percentage range by mass of the concrete with the carbon nanomaterial forming a 3-dimensional carbon nanomaterial network in the concrete matrix.

A concrete structure build from a concrete with a 3-dimensional carbon nanomaterial network includes a concrete matrix comprised of cement, sand, water, and aggregate and a carbon nanomaterial having a predetermined percentage range by mass of the concrete with the carbon nanomaterial forming a 3-dimensional carbon nanomaterial network in the concrete matrix.

### BRIEF DESCRIPTION OF THE DRAWINGS

FIGS. 1A and 1B are schematic drawings illustrating steps in a method for making concrete having a 3-dimensional carbon nanomaterial network;

FIG. 2 is a graph plotting dV(mV) vs dT(K) and Temperature (C) for various concrete samples made with carbon nanotubes (CNT) and carbon nanofibers (CNF) based EdenCrete liquid admixture samples;

FIG. 3 is a bar chart showing the resistivity of various mortar samples made with EdenCrete liquid admixture samples (Eden CNT-0.3% and Eden CNT-0.5%) and other nanocarbon materials added dry to similar mortar samples; and

FIG. 4 is a schematic drawing illustrating the additional steps of building a structure using the concrete and shielding the structure from radiofrequency and electromagnetic pulse radiation using the concrete.

### DETAILED DESCRIPTION

As used herein, the term “concrete” means a material in either a cured or an uncured state that includes cement, sand, aggregates and water. The term “cement” means hydratable cement such as Portland cement produced from clinker containing hydraulic calcium silicates. The term “pozzolan concrete” refers to a Portland-pozzolan blended concrete containing a significant amount of pozzolan, typically between 10 to 40% but sometimes as much as 90%.

The term “aggregate” means inert granular materials such as sand, gravel, crushed stone and minerals that, along with water and cement, are an essential ingredient in concrete. Aggregates, which typically account for 60 to 75 percent of the total volume of concrete, can be divided into two distinct categories—fine and coarse. Fine aggregates generally consist of natural sand or crushed stone with most particles passing through a ⅜-inch sieve. Coarse aggregates are any particles greater than 0.19 inch, but generally range between ⅜ and 1.5 inches in diameter, Gravels constitute the majority of coarse aggregate used in concrete with crushed stone making up most of the remainder.

The term “admixture” means ingredients added to concrete before or during mixing. The term “carbon nanomaterial enriched liquid concrete admixture” means an admixture containing a carbon nanomaterial in a liquid aqueous or organic solvent/compound mixture. U.S. Pat. No. 10,584,072, which is incorporated herein by reference, discloses carbon nanomaterial enriched liquid concrete admixtures containing carbon nanomaterial for making concrete. Exemplary concrete admixtures are manufactured in the US by Eden Innovations LTD as the EDENCRETE family of admixtures.

The term “concrete matrix” means the hard matrix that forms as cement reacts with water through a process called concrete hydration that hardens over several hours to form a hard matrix that binds the materials together into a durable stone-like material.

The term “carbon nanomaterial” means a material comprised of particles comprising an allotrope of carbon with one or more particle dimensions on the order of 500 nanometers (nm) or less. An exemplary carbon nanomaterial comprises “nanotubes” in the form of cylindrical nanostructures comprising one or more cylindrical tubes of atoms having a high length to diameter ratio. Another exemplary carbon nanomaterial comprises “nanofibers” in the form of cylindrical nanostructures with a high length to diameter ratio, with atomic layers in a stacked plate, cup, or cone configuration. Another exemplary carbon nanomaterial comprises “graphene”, which is the basic structure of many other allotropes of carbon, including carbon nanotubes, carbon nanofibers, graphite, and other fullerenes. Another exemplary carbon nanomaterial comprises “graphite” having a carbon crystalline atomic structure comprised of layers of graphene. Another exemplary carbon nanomaterial comprises “carbon black” in the form of a fine powder comprised of nanometer scale particles and agglomerates with a paracrystalline or polycrystalline atomic structure, usually made from decomposition and incomplete combustion of hydrocarbon feedstocks, but for the purposes of this disclosure, “carbon black” also include finely-ground charcoal, coal, or activated carbon materials. “Nano-silica” means silica a material with one or more particle dimensions on the order of 500 nanometers (nm) or less. “Unit cell” means the smallest group of particles of a substance that has the overall symmetry of a structure of that substance, and from which the entire structure can be built up by repetition in three dimensions.

A method for making concrete and concrete structures includes the step of providing a liquid admixture comprising a carbon nanomaterial having a predetermined percentage range by mass of admixture in a liquid aqueous or organic solvent/compound mixture. The carbon nanomaterial can comprise a mixture of any of the nanomaterials described above or can comprise a substantially pure single nanomaterial. The liquid admixture can be described as a “carbon nanomaterial enriched liquid concrete admixture”.

The liquid admixture can be fabricated by mixing a predetermined quantity of the carbon nanomaterial in carbon powder form with a predetermined quantity of liquid aqueous or organic solvent/compound mixture with intense, high energy, large scale mixing equipment. An exemplary percentage range of the carbon nanomaterial, can comprise 0.4% to 1.9% mass percentage of total mass of admixture. By way of example, the liquid aqueous or organic solvent/compound mixture can include a superplasticizer surfactant having a 2% to 9% mass percentage of total mass of admixture, a nano-silica based compound having a 5% to 21% mass percentage of total mass of admixture, and water having a 57% to 93% mass percentage of total mass of admixture. The liquid aqueous or organic solvent/compound mixture can also include an organic compound, which includes functional group(s) that contains a basic nitrogen atom with a lone pair as a part of the admixture, to increase early and/or late strength development in the concrete. A representative quantity of the organic compound can be from 0.5 to 95% by mass of the admixture.

Following providing of the liquid admixture, the method also includes the step of mixing the carbon nanomaterial enriched liquid concrete admixture with cement, aggregate and water in a dosage selected to form a concrete mix having a carbon nanomaterial structure comprised of individual carbon nanomaterial particles having a unit cell overlap. The mixing step can be performed using with intense, high energy, large scale mixing equipment.

Following the mixing step, the method also includes the step hardening the concrete mix to form a concrete matrix with the carbon nanomaterial forming a 3-dimensional carbon nanomaterial network incorporated into the concrete matrix. The 3-dimensional carbon nanomaterial network has a shielding effect against high frequency electromagnetic pulses and other radiofrequency signals. The hardening step can be performed using techniques that are known in the art such as curing under controlled temperature and humidity conditions, accelerated curing under elevated temperatures, and other methods.

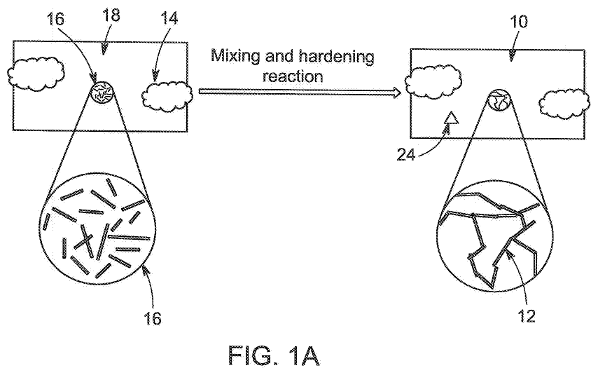

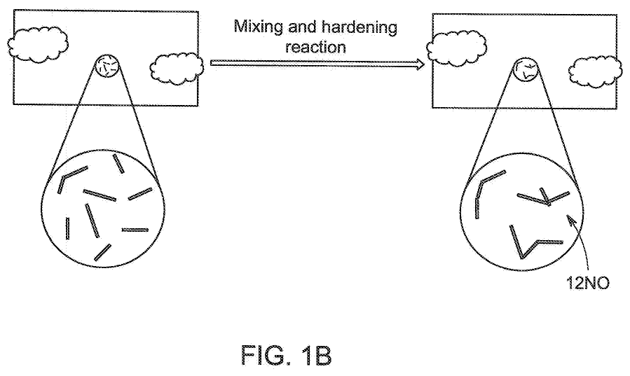

Referring to FIG. 1A, steps of the method for making concrete 10 having a 3-dimensional network 12 are illustrated in schematic form. In FIG. 1A, a concrete mix 18 includes an aggregate 14 and a carbon nanomaterial 16 having a unit cell overlap in which the particles of the carbon nanomaterial 14 have an overlapping geometry. For simplicity in FIG. 1A, the cement in the concrete 10 is not shown. FIG. 1A illustrates repositioning and alignment of the carbon nanomaterial 16 during a mixing and hardening reaction in which a dosage of the carbon nanomaterial 16 is above a threshold concentration such that fully spanning 3-dimensional networks 12 are formed in a concrete matrix 24. The mixing and hardening reaction occurs by control of the mixing step and hardening step as previously described. FIG. 1B illustrates an undesirable condition wherein repositioning and alignment of the carbon nanomaterial 16 during a sub-standard mixing and hardening reaction in which a dosage of the carbon nanomaterial 16 is below a threshold concentration such that no fully spanning 3-dimensional networks 12NO are formed. One factor in the undesirable condition is no unit cell overlap of the particles which make up the carbon nanomaterial 16.

Example 1: When EDENCRETE products have been used at higher concentrations for production of concrete, an unexpected effect of increased electrical and shielding potential have been observed, which we ascribe to the formation of 3-dimensional carbon nanomaterials networks forming in the paste of the concrete.

In “Standard Test Method for Electrical Indication of Concrete's Ability to Resist Chloride Ion Penetration”, i.e. ASTM C1202, an unusual behavior is seen when EDENCRETE products are added at higher dosages. Addition of carbon nanomaterial include in EDENCRETE product will typically at low dosages do as expected and reduce the chloride permeability as seen by the coulomb count in ASTM C1202 testing. However, as the dosage of carbon nanomaterial is increased a sudden increase in the Coulomb count is observed, for EDENCRETE this is typically observed at dosages from 0.6 to 1 gallon per yard=3 to 5 L/m³. Ponding trials, for example by ASTM C1556, ASTM C1543, or Nordtest 443, that directly determine the chloride concentration at different depths in the concrete reveal that EDENCRETE at higher dosages increase the concretes resistance to chloride penetration, i.e. reduce the chloride penetration, even more than lower dosages, as expected. Therefore it is clear that the increased coulombs measured by ASTM C1202 is a so called “false positive”, and that the increase in Coulombs measured is not caused by increased chloride penetration, but by an increased “leakage current” flowing through the 3-dimensional carbon nanoparticle network formed in the concrete.

The threshold dosage for 3-dimensional network formation with EDENCRETE typically starts from 0.6 gpy=3 L/m³ for standard concrete mixes. At this concentration significant changes to various electrical effects of the concrete are seen. This dosage fits a theoretical calculation on unit cell overlap for carbon nanoparticle interaction at around exactly this dosage. Based on carbon nanoparticle concentration in the EDENCRETE product degree of deagglomeration and size and distribution values of the Eden carbon nanoparticle products, a theoretical calculation on the dilution of the product into concrete predicts that significant non-Van der Waals carbon to carbon interaction, i.e., mainly end-to-end coordination will begin to happen at carbon nanomaterial concentrations of 25 grams per m³ and above, equal to 0.04214 lb/cy. For non-water based admixtures a similar change of electrical effects of the concrete can typically be seen at even lower dosages. This obviously depending on the carbon nanomaterial content of the admixture and on the dispersion and deagglomeration level and capability of the non-water-based admixture. For P-type EDENCRETE products, such as EDENCRETE Pz and EDENCRETE Pz7, the threshold concentration will typically be around 8 oz/cy=0.3 L/m³, which can be ascribed to a higher carbon nanomaterial concentration and even better protection against “simple” agglomeration from Van der Waals coordination of the carbon nanomaterials as they enter the concrete mix.

TABLE 1

| | | Average | Permeability |
|---|---|---|---|
| Mix | EdenCrete*gcpy | Coulombs | Rating |
| Class D Reference | NA | 1329 | Low |
| Class D | 0.5 gal | 846 | Very Low |
| Class D | 1 gal | 1646 | Low |
| Class D | 2 gal | 1754 | Low |
| | | Average | Permeability |
| Mix | Admix gpcy | Coulombs | Rating |
| Class G | EdenCrete* | 655 | Very Low |
| | 0.5 gal | | |
| Class G | Colloidal Silica | 825 | Very Low |
| | 0.5 gal | | |

*Increase coulombs reading from leakage current through the conductive carbon nanotubes

Another evidence for unique 3-dimensional network of nanoparticle in concrete and mortar with EDENCRETE is the observation of a dramatic increase in Seebeck coefficient, Sₑ, and thermoelectric power (TEP) by use of Eden's carbon nanomaterial in mortar and concrete samples. At a use of 5% EDENCRETE measured as weight percentage of cementitious, the EDENCRETE samples showed a large increased Seebeck coefficient of more than 8 times the reference, and almost 40% more than could be achieved with an equivalent dosage of a CNF product.

TABLE 2
Calculated apparent Seebeck coefficients and thermoelectric
power of the examined materials.

| | Apparent Seebeck | |
|---|---|---|
| Specimen | coefficient. | TEP |
| Designation | Se(μV/K) | (μV/K) |
| OPC | 129 ± 289 | 131 ± 289 |
| OPC-CNT | 1,057 ± 205 | 1,059 ± 205 |
| OPC-CNF | 768 ± 112 | 770 ± 112 |

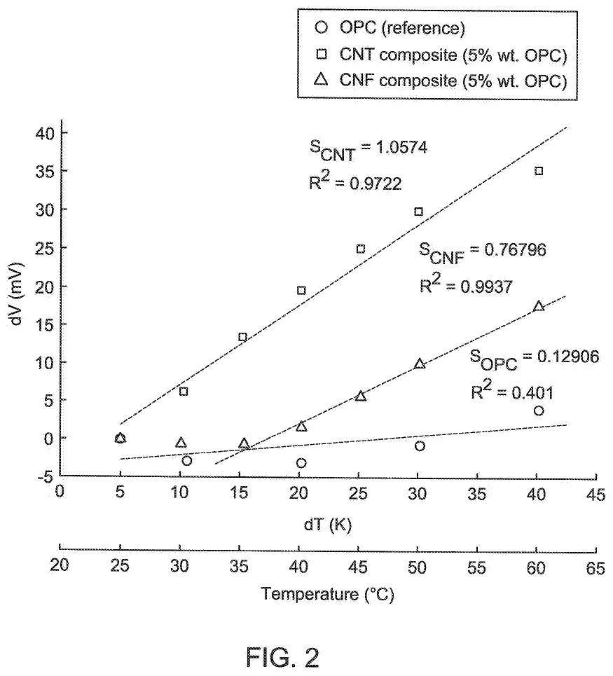

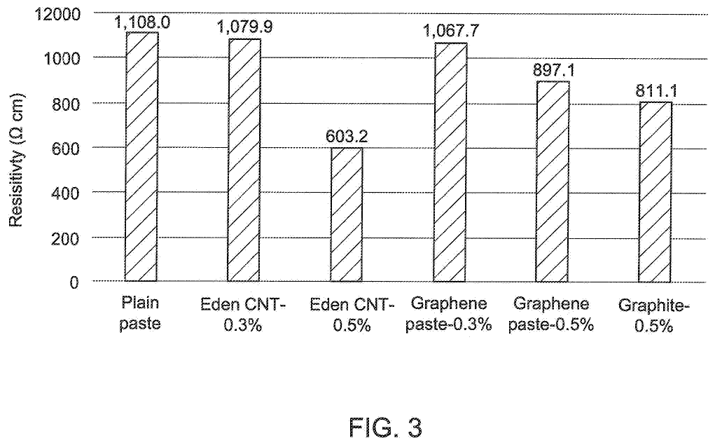

Example 2. Another example of 3-dimensional network formation with EDENCRETE products is from a conductivity study of cement paste samples with various types of alternative carbon nanomaterials added. During testing with LCR meter at a frequency of 100 kHz the apparent resistivity of the samples was measured. FIGS. 2 and 3 illustrate the results. These results also show evidence of a minimum threshold for 3-dimensional network formation, see that “Eden CNT-0.3%” shows no benefit as compared to the plain paste sample. Whereas the “Eden CNT-0.5%” sample is easily the best of all samples tested, including graphene and graphite samples. The percentages here are for actual carbon nanomaterial addition as compared to the cementitious.

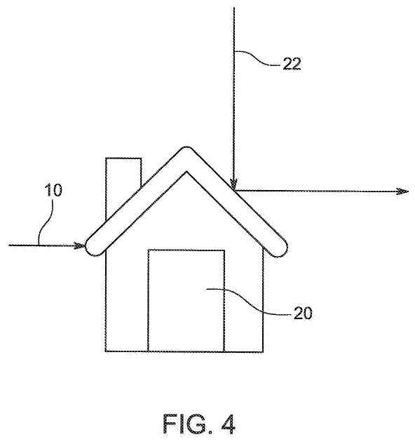

Referring to FIG. 4, the method can also include the step of building a structure 20 using the concrete 10, and the step of shielding the structure 20 from radiofrequency and electromagnetic pulse radiation using the concrete 10.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope

What is claimed:

1. A method for making concrete comprising:
providing a liquid admixture comprising a carbon nanomaterial having a predetermined percentage range by mass of admixture in a liquid aqueous or organic solvent/compound mixture, with the carbon nanomaterial in a pre-dispersed and deagglomerated state;
mixing the liquid admixture with cement and water in a dosage selected to form a concrete mix having a carbon nanomaterial structure comprised of individual carbon nanomaterial particles having a unit cell overlap; and
hardening the concrete mix to form a concrete matrix with the carbon nanomaterial forming a 3-dimensional carbon nanomaterial network incorporated into the concrete matrix.

2. The method of claim 1 further comprising building a structure using the concrete, and shielding the structure from radiofrequency and electromagnetic pulse radiation using the concrete.

3. The method of claim 1 wherein the dosage for an aqueous admixture in the concrete mix is at least 0.6 gallons per yard of concrete (gpy)=3 L/m³.

4. The method of claim 1 wherein the dosage for an organic solvent/compound mixture in the concrete mix is greater than 8 oz/cy=0.3 L/m³.

5. The method of claim 1 wherein the carbon nanomaterial in the concrete mix totals at least 25 g/m³=0.04214 lb/cy.

6. The method of claim 1 further comprising using the concrete for electromagnetic pulse (EMP) protection and radiofrequency shielding.

7. The method of claim 1 wherein the admixture includes a dispersion stabilizing chemistry for the carbon nanomaterial.

8. The method of claim 1 wherein the predetermined percentage range comprises 0.4% to 1.9% mass percentage of total mass of admixture.

9. The method of claim 1 wherein the liquid aqueous or organic solvent/compound mixture includes a superplasticizer surfactant having a 2% to 9% mass percentage of total mass of admixture, a nano-silica based compound having a 5% to 21% mass percentage of total mass of admixture, and water having a 57% to 93% mass percentage of total mass of admixture.

10. The method of claim 1 wherein the liquid aqueous or organic solvent/compound mixture includes an organic compound, which has a functional group that contains a basic nitrogen atom with a lone pair as a part of the admixture, to increase early and/or late strength development in the concrete.

11. The method of claim 10 wherein a quantity of the organic compound is from 0.5 to 95% by mas of the admixture.

12. A concrete comprising:
a concrete matrix comprised of cement, aggregate and a carbon nanomaterial having a predetermined percentage range by mass of the concrete with the carbon nanomaterial forming a 3-dimensional carbon nanomaterial network incorporated into the concrete matrix.
